(19) United States
(12) Patent Application Publication
(10) Pub. No.: US 2017/0290101 A1
(43) Pub. Date: Oct. 5, 2017

(54) COOKING SYSTEM

(71) Applicant: Wal-Mart Stores, Inc., Bentonville, AR (US)

(72) Inventors: Tammy Hawkins, Bentonville, AR (US); Daron L. Steward, Rogers, AR (US)

(21) Appl. No.: 15/472,631

(22) Filed: Mar. 29, 2017

Related U.S. Application Data
(63) Continuation-in-part of application No. 29/569,358, filed on Jun. 27, 2016.
(60) Provisional application No. 62/315,303, filed on Mar. 30, 2016.

(51) Int. Cl. H05B 3/68; A47J 37/06; A47J 36/00; F24C 7/10

(52) U.S. Cl. CPC H05B 3/68; F24C 7/10; A47J 37/0611; A47J 36/00

(57) ABSTRACT

Provided is a cooking system that provides for a plurality of cooking types in one apparatus. The cooking system includes an upper assembly releasably retaining one of a plurality of upper cooking plates and a lower assembly releasably retaining one of a plurality of lower cooking plates. The upper assembly is rotatably coupled to the lower assembly on an end of each assembly. The lower assembly supports the cooking system on a cooking surface and the upper assembly moves between an opened position with the retained upper cooking plate rotated away from the retained lower cooking plate and a closed position with the retained upper cooking plate adjacent the retained lower cooking plate. The plurality of upper cooking plates correspond to the plurality of lower cooking plates for one of eight predetermined types of cooking.

### RELATED APPLICATIONS

This application is a Continuation-in-Part of U.S. Design Patent Application No. 29/569,358, filed Jun. 27, 2016, and claims the benefit of U.S. Provisional Patent Application No. 62/307,669, filed Mar. 30, 2016, the contents of which are incorporated herein in their entirety.

### FIELD OF THE INVENTION

The invention relates generally to cooking system, and more specifically, to cooking system for providing a plurality of cooking types within a single apparatus.

### BACKGROUND

There are many different types of cooking systems. One such system includes indoor electric grills that utilize plates for cooking. These systems are limited in the ability to include several different types of plates for different types of cooking. Further, these systems lack the ability mix and match plates and do not provide a storage system of the plates that organizes the plates in a useable manner.

### BRIEF SUMMARY

In one aspect, provided is a cooking system comprising an upper assembly releasably retaining one of a plurality of upper cooking plates; and a lower assembly releasably retaining one of a plurality of lower cooking plates, wherein the upper assembly is rotatably coupled to the lower assembly on an end of each assembly, and wherein the lower assembly supports the cooking system on a cooking surface and the upper assembly moves between and opened position with the retained upper cooking plate rotated away from the retained lower cooking plate and closed position with the retained upper cooking plate adjacent the retained lower cooking plate, wherein: the plurality of upper cooking plates correspond to the plurality of lower cooking plates for one of eight predetermined types of cooking; a portion of the plurality of upper cooking plates are double sided cooking plates; and a portion of the plurality of lower cooking plates are double sided cooking plates.

In another aspect, provided is a cooking system comprising: an upper assembly comprising an upper heating element and means for releasably retaining one of a plurality of upper cooking plates adjacent the upper heating element; and a lower assembly comprising a lower heating element and means for releasably retaining one of a plurality of lower cooking plates adjacent the lower heating element, wherein the upper assembly is rotatably coupled to the lower assembly on an end of each assembly, and wherein the lower assembly supports the cooking system on a cooking surface and the upper assembly moves between an opened position with the retained upper cooking plate rotated away from the retained lower cooking plate and closed position with the retained upper cooking plate adjacent the retained lower cooking plate, wherein: the plurality of upper cooking plates correspond to the plurality of lower cooking plates for one of eight predetermined types of cooking; a portion of the plurality of upper cooking plates are double sided cooking plates; a portion of the plurality of lower cooking plates are double sided cooking plates; the plurality of upper cooking plates comprises a recessed tab engageable by the means for releasably retaining one of the plurality of upper cooking plates; and the plurality of lower cooking plates comprises a recessed tab engageable by the means for releasably retaining one of the plurality of upper cooking plates.

In another aspect, provided is a cooking system comprising: an upper assembly comprising an upper heating element and an upper securing device releasably retaining one of a plurality of upper cooking plates adjacent the upper heating element; and a lower assembly comprising a lower heating element and a lower securing device releasably retaining one of a plurality of lower cooking plates adjacent the lower heating element, wherein the upper assembly is rotatably coupled to the lower assembly on an end of each assembly, and wherein the lower assembly supports the cooking system on a cooking surface and the upper assembly moves between an opened position with the retained upper cooking plate rotated away from the retained lower cooking plate and closed position with the retained upper cooking plate adjacent the retained lower cooking plate, wherein: the plurality of upper cooking plates correspond to the plurality of lower cooking plates for one of eight predetermined types of cooking; a portion of the plurality of upper cooking plates are double sided cooking plates; a portion of the plurality of lower cooking plates are double sided cooking plates; the plurality of upper cooking plates comprises a recessed tab engageable by the means for releasably retaining one of the plurality of upper cooking plates; the plurality of lower cooking plates comprises a recessed tab engageable by the means for releasably retaining one of the plurality of upper cooking plates; and the plurality of upper cooking plates comprise stacking recesses and stacking protrusions on opposing sides of the plurality of upper cooking plates and the plurality of lower cooking plates comprise stacking recesses and stacking protrusions on opposing sides of the plurality of lower cooking plates, wherein the upper cooking plates and the lower cooking plates not being used are stacked and automatically aligned by engaging the stacking protrusions of one plate with the stacking recesses of an adjacent plate for storage.

In another aspect, A cooking system sold as a kit comprising: four upper cooking plates and four lower cooking plates; an upper assembly comprising a handle on one end, an upper heating element and an upper securing device releasably retaining one of the four upper cooking plates adjacent the upper heating element; and a lower assembly comprising a temperature control, a lower heating element and a lower securing device releasably retaining one of the four lower cooking plates adjacent the lower heating element, wherein the upper assembly is rotatably coupled on an end opposite the handle to the lower assembly on an end of opposite the temperature control, and wherein the lower assembly supports the cooking system on a cooking surface and the upper assembly moves between an opened position with the retained upper cooking plate rotated away from the retained lower cooking plate and a closed position with the retained upper cooking plate adjacent the retained lower cooking plate, wherein: the four upper cooking plates correspond to the four lower cooking plates for one of eight predetermined types of cooking consisting of a cupcake cooking type, a muffin cooking type, a grilling cooking type, a griddle cooking type, a grilling/griddle cooking type, a panini press cooking type, an omelet cooking type, and a waffle cooking type; one of the upper cooking plates and one of the lower cooking plates are a single sided cooking plate used for the cupcake cooking type and the muffing cooking type; one of the upper cooking plates and one of the lower cooking plates are double sided cooking plates used for the grilling cooking type, the griddle cooking type, and the grilling/griddle cooking type; one of the upper cooking plates and one of the lower cooking plates are double sided cooking plates used for the panini press cooking type and the omelet cooking type; one of the upper cooking plates and one of the lower cooking plates are double sided cooking plates used for the waffle cooking type; and the four upper cooking plates comprise stacking recesses and stacking protrusions on opposing sides of the four upper cooking plates and the lower cooking plates comprise stacking recesses and stacking protrusions on opposing sides of the four lower cooking plates, wherein the upper cooking plates and the lower cooking plates not being used are stacked and automatically aligned by engaging the stacking protrusions of one plate with the stacking recesses of an adjacent plate for storage.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a perspective view of a cooking system in a closed, in accordance with some embodiments.

FIG. 2 is a perspective view of a cooking system in an opened position, in accordance with some embodiments.

FIG. 3 is another perspective view of a cooking system in an opened position, in accordance with some embodiments.

FIG. 4 is a perspective view of an upper assembly of a cooking system, in accordance with some embodiments.

FIG. 5 is a perspective view of a lower assembly of a cooking system, in accordance with some embodiments.

FIG. 6 is a section view of a lower assembly of s cooking system, in accordance with some embodiments.

FIG. 7 is a view of a set of plates for a cupcake cooking type and a muffing cooking type, in accordance with some embodiments.

FIG. 8 is a view of a set of double-sided plates for a grill and a griddle cooking type, in accordance with some embodiments.

FIG. 9 is a view of a set of double-sided plates for a panini and an omelet cooking type, in accordance with some embodiments.

FIG. 10 is a view of a set of plates for a waffle cooking type, in accordance with some embodiments.

FIG. 11 is a perspective section view of a stack of cooking plates, in accordance with some embodiments.

### DETAILED DESCRIPTION

Many people seek to have various options for cooking the food they eat. Further, these people seek to have a convenient way to cook that also provides easy storage and use. Embodiments of the present invention include a cooking system that is a multi-purpose cooking system that can be bundled into one apparatus. This provides for space saving, ease of use and cleaning, and further can replace several small appliances or cooking devices.

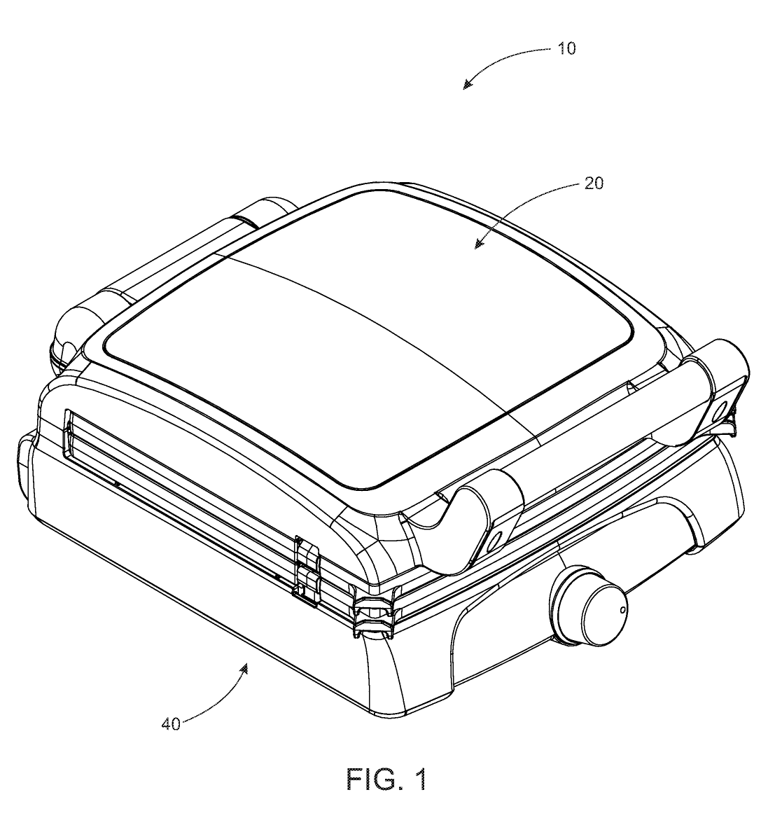

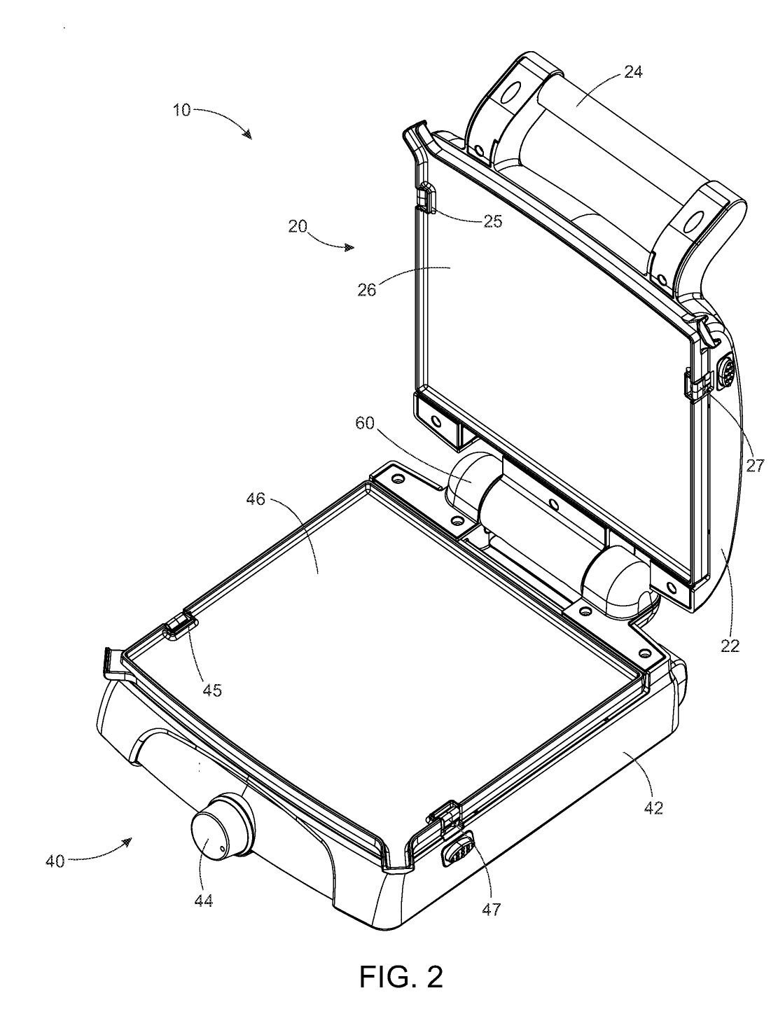

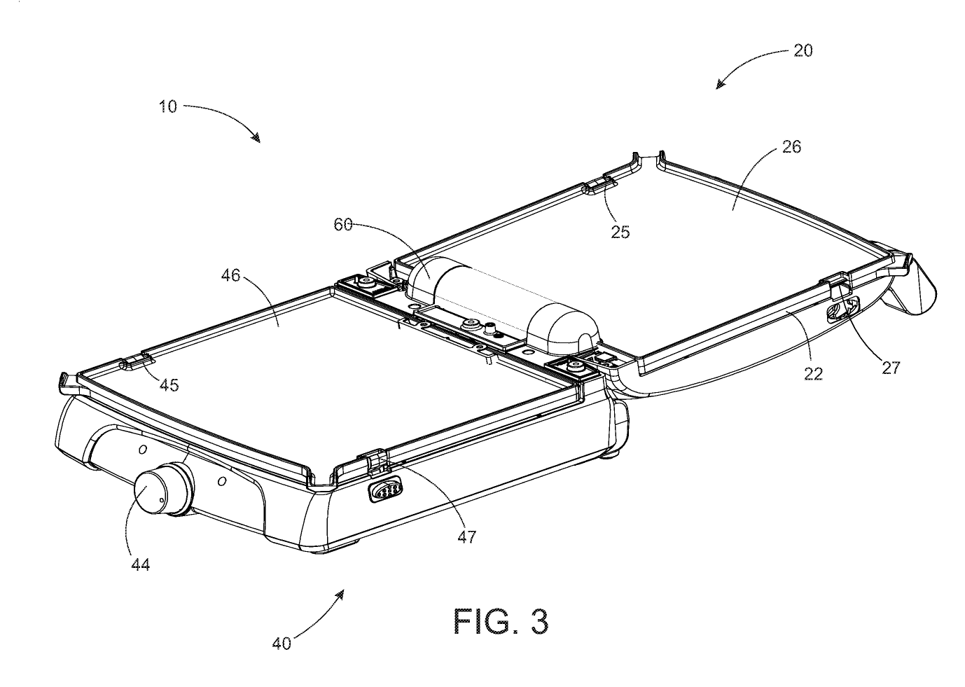

FIGS. 1 is a perspective view of a cooking system 10 in a closed position and FIGS. 2 and 3 are perspective views of the cooking system 10 in an opened position. The cooking system 10 includes an upper assembly 20 and a lower assembly 40. The upper assembly 20 includes an upper housing 22, a handle 24 coupled to an end of the upper housing 22, and an upper cooking plate 26 removably coupled to the upper housing 22. The lower assembly 40 includes a lower housing 42, feet 43 coupled on a bottom side of the lower housing 42, a temperature control 44 operatively coupled to the bottom housing 42, and a lower cooking plate 46 coupled to the lower housing 42. The upper assembly 20 is rotatably coupled to the lower assembly 40 on an end of each assembly by hinge 60, wherein hinge 60 is coupled to the upper assembly 20 on an end opposite the end the handle 24 is coupled and the hinge 60 is coupled to the lower assembly 40 on an end opposite the end the temperature control 44 is coupled. The lower assembly 40 supports the cooking system 10 on a cooking surface. This may be accomplished by use of the feet 43, wherein the feet 43 rest on the cooking surface and the support the lower housing 40 off of the cooking surface. The upper assembly 20 is then free to move between an opened position and a closed position. The opened position is depicted in FIGS. 2 and 3 wherein the retained upper cooking plate 26 is rotated away from the retained lower cooking plate 46. The closed position is depicted in FIG. 1 wherein the retained upper cooking plate 26 is adjacent the retained lower cooking plate 46.

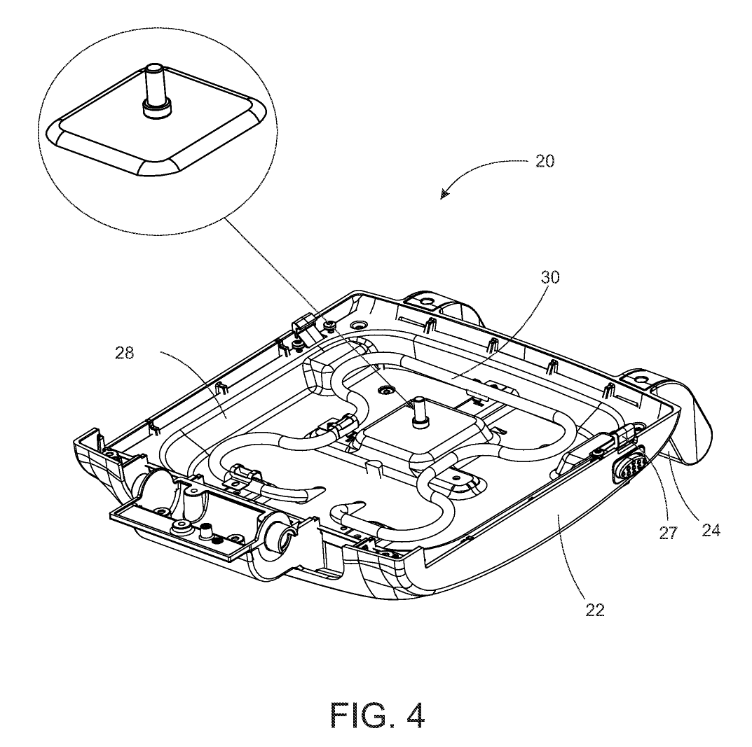

Referring further to FIG. 4, a perspective view of the upper assembly 20 without an upper cooking plate 26 coupled to it, the upper assembly 20 may include an upper heating element 30 coupled to an upper reflecting board 28. The upper reflecting board 28 operates to reflect heat away from the upper housing 22 and to the upper cooking plate 26. The upper assembly 20 may further include an upper plate retaining member 27. The upper plate retaining member 27 may engage an upper plate retaining recess 25 of the upper cooking plate 26 to releasably retain the upper cooking plate 26 to the upper assembly and adjacent the upper heating element 30 and the upper reflecting board 28. In some embodiments, the upper plate retaining member 27 is a clip that releasably engages the upper plate retaining recess 25. In other embodiments the upper plate retaining member 27 is a means for retaining the upper cooking plate 26 to the upper housing 22. Other retaining members are contemplated that may releasably retain the upper cooking plate 26 to the upper housing 22. Further, more than one upper plate retaining member 27 may be utilized, and the upper cooking plate 26 may include more than one upper plate retaining recess 25 to correspond to each upper plate retaining member 27.

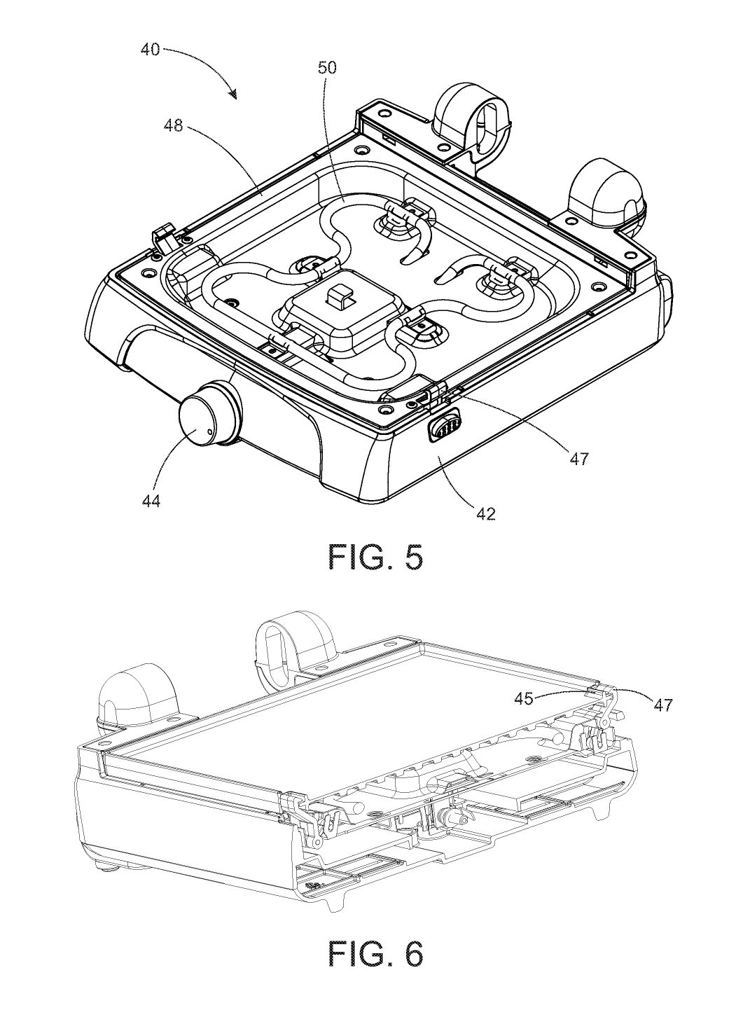

Referring further to FIG. 5, a perspective view of the lower assembly 40 without a lower cooking plate 46 coupled to it, the lower assembly 40 may include a lower heating element 50 coupled to a lower reflecting board 48. The lower reflecting board 48 operates to reflect heat away from the lower housing 42 and to the lower cooking plate 46. The lower assembly 40 may further include a lower plate retaining member 47. The lower plate retaining member 47 may engage a lower plate retaining recess 45 of the lower cooking plate 46 to releasably retain the lower cooking plate 46 to the lower assembly and adjacent the lower heating element 50 and the lower reflecting board 48. In some embodiments, the lower plate retaining member 47 is a clip that releasably engages the lower plate retaining recess 45. In other embodiments the lower plate retaining member 47 is a means for retaining the lower cooking plate 46 to the lower housing 42. Other retaining members are contemplated that may releasably retain the lower cooking plate 46 to the lower housing 42. Further, more than one lower plate retaining member 47 may be utilized, and the lower cooking plate 46 may include more than one lower plate retaining recess 45 to correspond to each lower plate retaining member 47.

The hinge 60 that rotatably coupled the upper assembly 20 to the lower assembly 40 may further operate to allow an electrical connection between the upper heating element 30 and the temperature control 44. The lower heating element 50 may also include an electrical connection with the temperature control 44. This electrical connection of both the upper heating element 30 and the lower heating element 50 with the temperature control 44 provides the ability to maintain the upper heating element 30 and the lower heating element 50 at substantially the same temperature. The temperature control 44 may include thermostats (not shown), wherein the thermostats determine the temperature of the lower heating element 50 and/or the upper heating element 30 and controls the current flowing to the lower heating element 50 and the upper heating element in response to the temperature crossing a user set threshold. The user set threshold may be a temperature setting on a dial or other markings on an outer surface of the lower assembly, wherein the temperature control 44 may be rotated to a position that is identified for the desired temperature. While not shown, it will be understood that embodiments of the cooking device 10 may include a power source, such as a cord that may be coupled to a socket to provide power, a battery, or other type of power source. Further, the cooking device may provide the necessary circuitry, electronics and the like to control the cooking temperature and operation of the heating elements and the like.

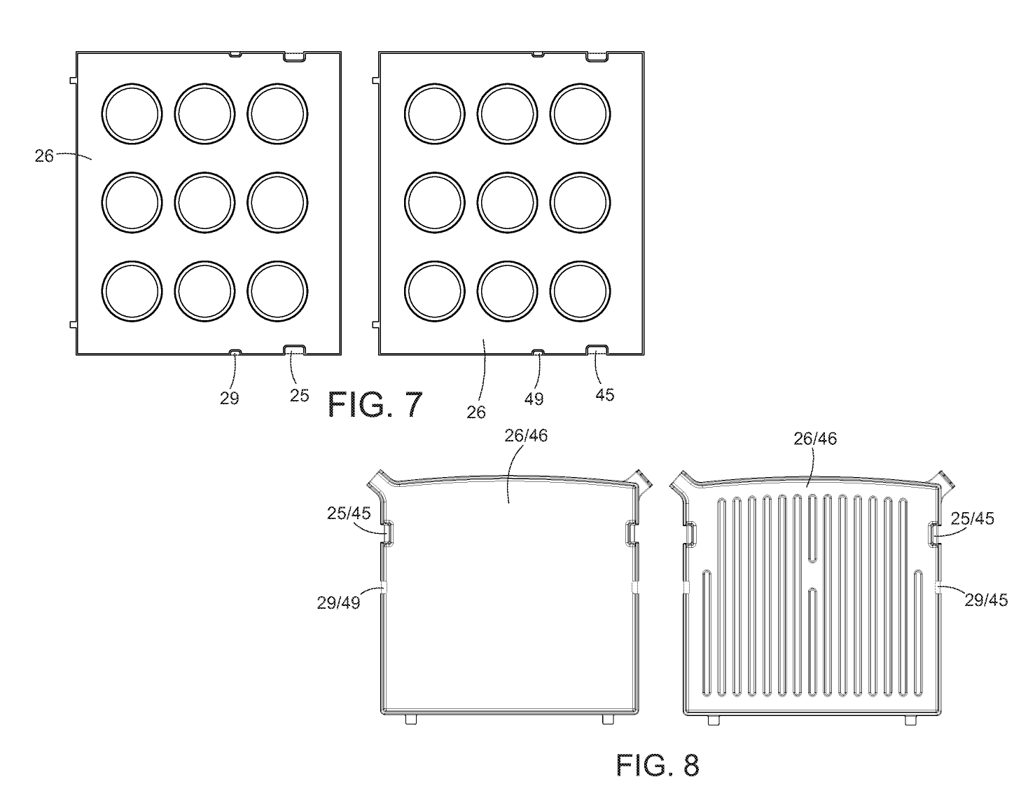

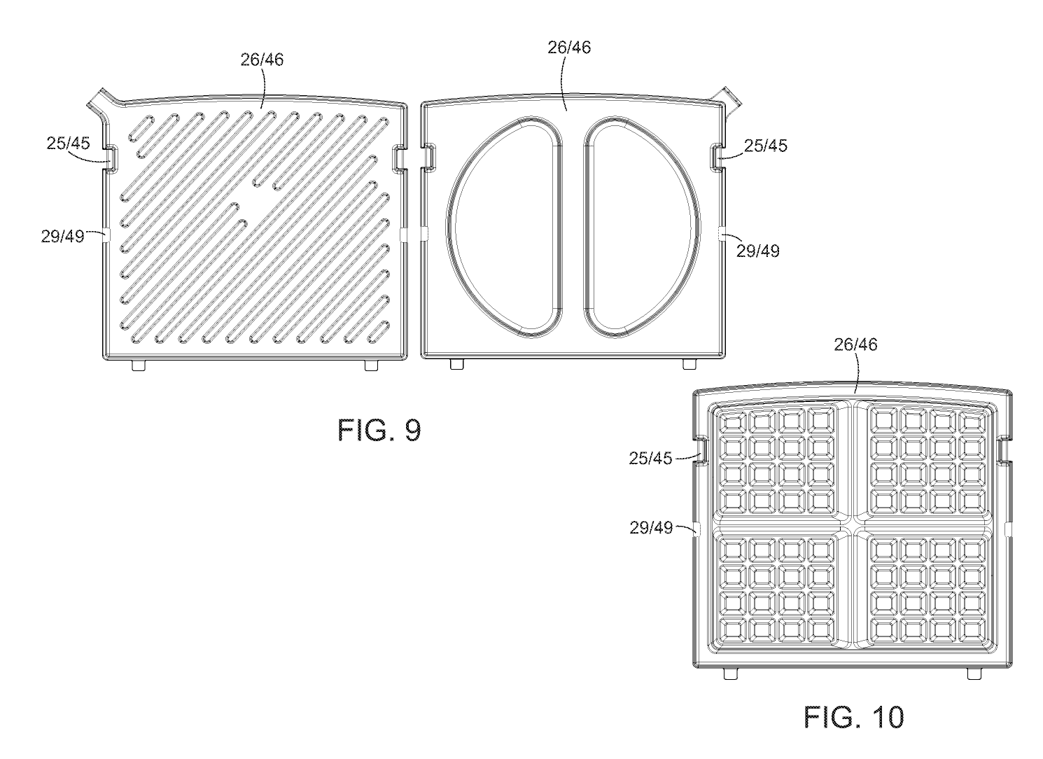

Referring again to the drawings, FIGS. 7-10 depicts various types of upper cooking plates 26 and lower cooking plates 46 in accordance with embodiments of the present invention. FIG. 7 depicts a set of plates for a cupcake cooking type and a muffing cooking type. FIG. 8 is a view of a set of double-sided plates for a grill and a griddle cooking type. FIG. 9 is a view of a set of double-sided plates for a panini and an omelet cooking type. FIG. 10 is a view of a set of plates for a waffle cooking type.

With regard to FIG. 7, the upper cooking plate 26 and the lower cooking plate 46 may be single sided cooking plates with corresponding recesses used for cooking cupcakes or muffins. For example, and without limitation, the lower cooking plate 46 depicts a plurality of recess sized to receive a cup cake liner or to be used as a bottom portion of a cupcake or a muffin, and the upper cooking plate 26 includes a plurality of corresponding recesses to be used as a top portion of a cupcake or a muffin. In at least this way, the upper cooking plate 26 and the lower cooking plate 46 depicted in FIG. 7 operate as single sided cooking plates for a cupcake cooking type and single sided cooking plates for a muffin cooking type.

With regard to FIG. 8, the upper cooking plate 26 and the lower cooking plate 46 may be double sided cooking plates, wherein one side is a grill and the other side is a griddle. The grill side of the upper cooking plate 26 and the lower cooking plate 46 may include protrusions to provide the grill portion of the cooking plate, and the griddle side of the upper cooking plate 26 and the lower cooking plate 46 is a flat surface. The upper cooking plate 26 may be releasably coupled to the upper housing 22 with either side of the plate 26 being used for cooking. The lower cooking plate 46 may be releasably coupled to the lower housing 42 with either side of the plate 46 being used for cooking. In order to provide a grilling cooking type, the upper cooking plate 26 and the lower cooking plate 46 are each coupled to the upper housing 22 and lower housing respectively with the grill side of the plates 26 and 46 in a position to be used for cooking. In order to provide a griddle cooking type, the upper cooking plate 26 and the lower cooking plate 46 are each coupled to the upper housing 22 and lower housing respectively with the griddle side of the plates 26 and 46 in a position to be used for cooking. In order to provide a grilling/griddle combination cooking type, the upper cooking plate 26 and the lower cooking plate 46 is coupled to the upper housing 22 and lower housing respectively with the grill side of one of the plates 26 and 46 in a position to be used for cooking and the griddle side of one of the plates 26 and 46 in a position to be used for cooking, wherein one plate has a grill side to be used and the other plate has a griddle side to be used. In at least this way, the upper cooking plate 26 and the lower cooking plate 46 depicted in FIG. 8 may be used for a grilling cooking type, a griddle cooking type and a grilling/griddle combination cooking type.

With regard to FIG. 9, the upper cooking plate 26 and the lower cooking plate 46 may be double sided cooking plates, wherein one side is a panini press and the other side is an omelet cooking side. The panini press side of the upper cooking plate 26 and the lower cooking plate 46 may include protrusions that are angled to provide the panini press portion of the cooking plate, and the omelet side of the upper cooking plate 26 and the lower cooking plate 46 includes one or more recesses in order to form the omelet on both sides. The upper cooking plate 26 may be releasably coupled to the upper housing 22 with either side of the plate 26 being used for cooking. The lower cooking plate 46 may be releasably coupled to the lower housing 42 with either side of the plate 46 being used for cooking. In order to provide a panini press cooking type, the upper cooking plate 26 and the lower cooking plate 46 are each coupled to the upper housing 22 and lower housing respectively with the panini side of the plates 26 and 46 in a position to be used for cooking. In order to provide an omelet cooking type, the upper cooking plate 26 and the lower cooking plate 46 are each coupled to the upper housing 22 and lower housing respectively with the omelet side of the plates 26 and 46 in a position to be used for cooking. In at least this way, the upper cooking plate 26 and the lower cooking plate 46 depicted in FIG. 9 may be used for a panini press cooking type and an omelet cooking type.

With regard to FIG. 10, the upper cooking plate 26 and the lower cooking plate 46 may be single sided cooking plates with corresponding recesses used for cooking waffles. For example, and without limitation, the lower cooking plate 46 depicts a plurality of waffle shaped recess and the upper cooking plate 26 includes a plurality of corresponding waffle shaped recesses. In at least this way, the upper cooking plate 26 and the lower cooking plate 46 depicted in FIG. 10 operate as single sided cooking plates for a waffle cooking type.

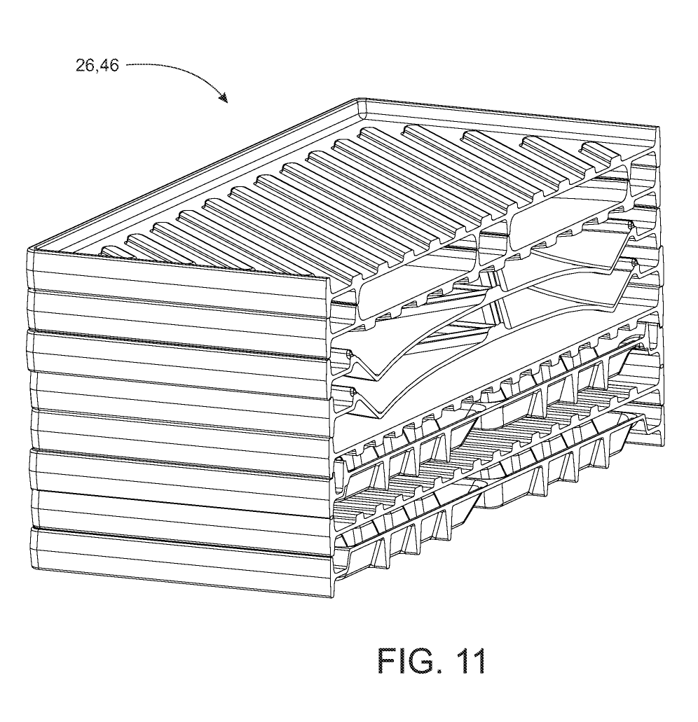

Referring to FIGS. 7-11, each of the upper cooking plates 26 and the lower cooking plates 46 include an upper plate retaining recess 25 and a lower plate retaining recess 45 that may be used to releasably couple the plates 26 and 46 to the upper housing 22 and lower housing 42 respectively. Additionally, one side of the upper cooking plates 26 and the lower cooking plates 46 include stacking recesses 29. The opposing side of the upper cooking plates 26 and the lower cooking plates 46 include stacking protrusions 49. The stacking recesses 29 and stacking protrusions 49 correspond to each other such that plates not coupled to the upper housing 22 or the lower housing 42 may be stacked and automatically aligned by engaging the stacking protrusions 49 of one plate with the stacking recesses 29 of an adjacent plate, as shown in FIG. 11. This allows the unused cooking plates 26 and 46 to be stacked for easy storage and form a resistance for one or more of the plates to slide off of the stack of plates.

It will be understood that in some embodiments, the cooking system 10 may be sold as a kit, wherein the cooking system includes the upper assembly and lower assembly coupled together with all if their respective components and a set of cooking plates depicted in FIGS. 7-10 to provide for 8 cooking types consisting of a cupcake cooking type, a muffin cooking type, a grilling cooking type, a griddle cooking type, a grilling/griddle cooking type, a panini press cooking type, an omelet cooking type, and a waffle cooking type. In at least this way, the cooking system 10 is an 8-in-1 cooking system, wherein the cooking device 10 provides for eight cooking types with one apparatus. It will also be understood that users may mix and match plates for determined cooking types, such as, but not limited to, utilizing a bottom play for a muffin cooking type and a top plate for a griddle cooking type, and any combination thereof. In other words, the plates for the eight predetermined types of cooking may be interchangeably used to create other combination cooking types.

While the invention has been shown and described with reference to specific preferred embodiments, it should be understood by those skilled in the art that various changes in form and detail may be made therein without departing from the spirit and scope of the invention as defined by the following claims.

What is claimed is:

1. A cooking system comprising:
an upper assembly releasably retaining one of a plurality of upper cooking plates; and
a lower assembly releasably retaining one of a plurality of lower cooking plates, wherein the upper assembly is rotatably coupled to the lower assembly on an end of each assembly, and wherein the lower assembly supports the cooking system on a cooking surface and the upper assembly moves between an opened position with the retained upper cooking plate rotated away from the retained lower cooking plate and a closed position with the retained upper cooking plate adjacent the retained lower cooking plate, wherein:
the plurality of upper cooking plates correspond to the plurality of lower cooking plates for one of eight predetermined types of cooking;
a portion of the plurality of upper cooking plates are double sided cooking plates; and
a portion of the plurality of lower cooking plates are double sided cooking plates.

2. The system of claim 1, wherein the plurality of upper plates correspond to the plurality of lower cooking plates for one of a cupcake type of cooking, a muffin type of cooking, a waffle type of cooking, a grilling type of cooking, a griddle type of cooking, a grill/griddle combination type of cooking, a panini type of cooking or an omelet type of cooking.

3. The system of claim 2, wherein the one of the plurality of upper cooking plates and one of the plurality of lower cooking plates are single sided and correspond for both the cupcake type of cooking and the muffin type of cooking.

4. The system of claim 2, wherein the one of the plurality of upper cooking plates and one of the plurality of lower cooking plates are double sided with a grill on one side and a griddle on the opposing side for the grilling type of cooking, the griddle type of cooking, the grill/griddle combination type of cooking.

5. The system of claim 2, wherein the one of the plurality of upper cooking plates and one of the plurality of lower cooking plates are double sided with a panini press on one side and an omelet maker on the opposing side for the panini type of cooking and the omelet type of cooking.

6. The system of claim 2, wherein the one of the plurality of upper cooking plates and one of the plurality of lower cooking plates are single sided and correspond for the waffle type of cooking.

7. The system of claim 1, further comprising an upper heating element coupled in the upper assembly and a lower heating element coupled within the lower assembly.

8. The system of claim 7, further comprising a temperature control, wherein the temperature control simultaneously controls temperature of the upper heating element and the lower heating element.

9. The system of claim 8, wherein one of the plurality of upper cooking plates is releasably retained within the upper assembly adjacent to the upper heating element, wherein heat transfers from the heating element to the retained upper cooking plate.

10. The system of claim 9, wherein one of the plurality of lower cooking plates is releasably retained within the lower assembly adjacent to the lower heating element, wherein heat transfers from the lower heating element to the retained lower cooking plate.

11. A cooking system comprising:
an upper assembly comprising an upper heating element and means for releasably retaining one of a plurality of upper cooking plates adjacent the upper heating element; and
a lower assembly comprising a lower heating element and means for releasably retaining one of a plurality of lower cooking plates adjacent the lower heating element, wherein the upper assembly is rotatably coupled to the lower assembly on an end of each assembly, and wherein the lower assembly supports the cooking system on a cooking surface and the upper assembly moves between and opened position with the retained upper cooking plate rotated away from the retained lower cooking plate and closed position with the retained upper cooking plate adjacent the retained lower cooking plate, wherein:
the plurality of upper cooking plates correspond to the plurality of lower cooking plates for one of eight predetermined types of cooking;
a portion of the plurality of upper cooking plates are double sided cooking plates;
a portion of the plurality of lower cooking plates are double sided cooking plates;
the plurality of upper cooking plates comprises a recessed tab engageable by the means for releasably retaining one of the plurality of upper cooking plates; and
the plurality of lower cooking plates comprises a recessed tab engageable by the means for releasably retaining one of the plurality of upper cooking plates.

12. The system of claim 11, wherein the plurality of upper plates correspond to the plurality of lower cooking plates for one of a cupcake type of cooking, a muffin type of cooking, a waffle type of cooking, a grilling type of cooking, a griddle type of cooking, a grill/griddle combination type of cooking, a panini type of cooking or an omelet type of cooking.

13. The system of claim 12, wherein the one of the plurality of upper cooking plates and one of the plurality of lower cooking plates are single sided and correspond for both the cupcake type of cooking and the muffin type of cooking.

14. The system of claim 12, wherein the one of the plurality of upper cooking plates and one of the plurality of lower cooking plates are double sided with a grill on one side and a griddle on the opposing side for the grilling type of cooking, the griddle type of cooking, the grill/griddle combination type of cooking.

15. The system of claim 12, wherein the one of the plurality of upper cooking plates and one of the plurality of lower cooking plates are double sided with a panini press on one side and an omelet maker on the opposing side for the panini type of cooking and the omelet type of cooking.

16. The system of claim 12, wherein the one of the plurality of upper cooking plates and one of the plurality of lower cooking plates are single sided and correspond for the waffle type of cooking.

17. The system of claim 16, further comprising a temperature control, wherein the temperature control simultaneously controls temperature of the upper heating element and the lower heating element.

18. A cooking system comprising:
an upper assembly comprising an upper heating element and an upper securing device releasably retaining one of a plurality of upper cooking plates adjacent the upper heating element; and
a lower assembly comprising a lower heating element and a lower securing device releasably retaining one of a plurality of lower cooking plates adjacent the lower heating element, wherein the upper assembly is rotatably coupled to the lower assembly on an end of each assembly, and wherein the lower assembly supports the cooking system on a cooking surface and the upper assembly moves between and opened position with the retained upper cooking plate rotated away from the retained lower cooking plate and closed position with the retained upper cooking plate adjacent the retained lower cooking plate, wherein:
the plurality of upper cooking plates correspond to the plurality of lower cooking plates for one of eight predetermined types of cooking;
a portion of the plurality of upper cooking plates are double sided cooking plates;
a portion of the plurality of lower cooking plates are double sided cooking plates;
the plurality of upper cooking plates comprises a recessed tab engageable by the means for releasably retaining one of the plurality of upper cooking plates;
the plurality of lower cooking plates comprises a recessed tab engageable by the means for releasably retaining one of the plurality of upper cooking plates; and
the plurality of upper cooking plates comprise stacking recesses and stacking protrusions on opposing sides of the plurality of upper cooking plates and the plurality of lower cooking plates comprise stacking recesses and stacking protrusions on opposing sides of the plurality of lower cooking plates, wherein the upper cooking plates and the lower cooking plates not being used are stacked and automatically aligned by engaging the stacking protrusions of one plate with the stacking recesses of an adjacent plate for storage.

19. The system of claim 18, wherein the plurality of upper plates correspond to the plurality of lower cooking plates for one of a cupcake type of cooking, a muffin type of cooking, a waffle type of cooking, a grilling type of cooking, a griddle type of cooking, a grill/griddle combination type of cooking, a panini type of cooking or an omelet type of cooking.

20. The system of claim 19, wherein the one of the plurality of upper cooking plates and one of the plurality of lower cooking plates are single sided and correspond for both the cupcake type of cooking and the muffin type of cooking.

21. The system of claim 19, wherein the one of the plurality of upper cooking plates and one of the plurality of lower cooking plates are double sided with a grill on one side and a griddle on the opposing side for the grilling type of cooking, the griddle type of cooking, the grill/griddle combination type of cooking.

22. The system of claim 19, wherein the one of the plurality of upper cooking plates and one of the plurality of lower cooking plates are double sided with a panini press on one side and an omelet maker on the opposing side for the panini type of cooking and the omelet type of cooking.

23. The system of claim 19, wherein the one of the plurality of upper cooking plates and one of the plurality of lower cooking plates are single sided and correspond for the waffle type of cooking.

24. The system of claim 18, further comprising a temperature control, wherein the temperature control simultaneously controls temperature of the upper heating element and the lower heating element.

25. A cooking system sold as a kit comprising:
four upper cooking plates and four lower cooking plates;
an upper assembly comprising a handle on one end, an upper heating element and an upper securing device releasably retaining one of the four upper cooking plates adjacent the upper heating element; and
a lower assembly comprising a temperature control, a lower heating element and a lower securing device releasably retaining one of the four lower cooking plates adjacent the lower heating element, wherein the upper assembly is rotatably coupled on an end opposite the handle to the lower assembly on an end of opposite the temperature control, and wherein the lower assembly supports the cooking system on a cooking surface and the upper assembly moves between an opened position with the retained upper cooking plate rotated away from the retained lower cooking plate and a closed position with the retained upper cooking plate adjacent the retained lower cooking plate, wherein:
the four upper cooking plates correspond to the four lower cooking plates for one of eight predetermined types of cooking consisting of a cupcake cooking type, a muffin cooking type, a grilling cooking type, a griddle cooking type, a grilling/griddle cooking type, a panini press cooking type, an omelet cooking type, and a waffle cooking type;
one of the upper cooking plates and one of the lower cooking plates are a single sided cooking plate used for the cupcake cooking type and the muffing cooking type;
one of the upper cooking plates and one of the lower cooking plates are double sided cooking plates used for the grilling cooking type, the griddle cooking type, and the grilling/griddle cooking type;
one of the upper cooking plates and one of the lower cooking plates are double sided cooking plates used for the panini press cooking type and the omelet cooking type;
one of the upper cooking plates and one of the lower cooking plates are double sided cooking plates used for the waffle cooking type; and
the four upper cooking plates comprise stacking recesses and stacking protrusions on opposing sides of the four upper cooking plates and the lower cooking plates comprise stacking recesses and stacking protrusions on opposing sides of the four lower cooking plates, wherein the upper cooking plates and the lower cooking plates not being used are stacked and automatically aligned by engaging the stacking protrusions of one plate with the stacking recesses of an adjacent plate for storage.

26. The kit of claim 25, wherein plates for the eight predetermined types of cooking may be interchangeably used to create other combination cooking types.
